(19) United States
(12) Patent Application Publication
(10) Pub. No.: US 2021/0193424 A1
(43) Pub. Date: Jun. 24, 2021

(54) RESTORING ELEMENT, AND ELECTRICAL SWITCH HAVING SUCH A RESTORING ELEMENT

(71) Applicant: Siemens Aktiengesellschaft, Muenchen (DE)

(72) Inventors: Pawel BIEDUNKIEWICZ, Berlin (DE); Joerg-Uwe DAHL, Werder (DE); Markus FALTERMEIER, Regensburg (DE)

(73) Assignee: Siemens Aktiengesellschaft, Muenchen (DE)

(21) Appl. No.: 17/124,615

(22) Filed: Dec. 17, 2020

(30) Foreign Application Priority Data
Dec. 20, 2019 (DE) 10 2019 220 433.3

(51) Int. Cl. H01H 71/52; H01H 71/43

(52) U.S. Cl. CPC H01H 71/52; H01H 71/43

(57) ABSTRACT

A restoring element is for an electrical switch. In an embodiment, the restoring element is constructed in two parts from a first part and a second part. The two parts are configured to converge in a first direction for tripping the electrical switch and the two parts do not necessarily converge in a second direction for resetting the electrical switch, the second direction being different from the first direction. Further, the second part of the restoring element includes a restoring cam which is configured to interact with a handle of a switching mechanism of the electrical switch, such that, during resetting of the electrical switch, the restoring element is configured to be rotated by the handle in the second direction for resetting the electrical switch.

### PRIORITY STATEMENT

The present application hereby claims priority under 35 U.S.C. § 119 to German patent application number DE 102019220433.3 filed Dec. 20, 2019, the entire contents of which are hereby incorporated herein by reference.

### FIELD

Embodiments of the invention generally relate to a restoring element for an electrical switch and to an electrical switch having such a restoring element.

### BACKGROUND

Current-limiting switching devices, in particular current-limiting circuit breakers, for example in the form of MCCBs (Molded Case Circuit Breakers), are typically used in extensively branched power distribution networks. It is customary to conduct selective staggering with a minimum nominal current distance between the switching devices involved. Each branching plane can be protected here against overloads and short circuits that occur by a switching device which is appropriately dimensioned depending on the connected consumers.

For example, a switching device which is arranged closest to a consumer and which is often referred to as a consumer-close or downstream switching device is configured for the lowest nominal current here. If a short-circuit current then flows both through the consumer-close switching device and through a switching device which is arranged above the consumer-close switching device in the hierarchy of the power distribution network and is often referred to as a consumer-remote or upstream switching device, only the consumer-close switching device is intended to switch off. In other words, in the event of a fault (short circuit), only the switching device which is closest to the event is intended to interrupt the current flow.

Upon opening, the switching contact pairs of the consumer-close and of the consumer-remote switching device strike an electric arc, wherein the opening width of the switching contact pairs and also the electric arc energy are higher in the case of the consumer-close switching device on account of the lower mass moment of inertia of its movable current path including the switching contacts. This opening, which under some circumstances is only a single-pole opening, has to be followed by all-pole switch off of the consumer-close switching device. The consumer-remote switching device must not switch off in order to not disconnect further consumers from the power distribution network. However, the consumer-remote switching device must act in an assisting manner by briefly raising the switching contacts, that is to say must contribute to switch off of the consumer-close switching device by limiting the current for example.

Switching devices which act in such a staggered manner in power distribution networks behave selectively. In order to achieve this selectivity, the switching devices lying closest to the fault have to interrupt the current paths of all of the switching devices more rapidly than the switching devices arranged thereabove.

DE 691 10 540 T2 and DE 692 17 441 T2 each disclose electrical switching arrangements in the form of circuit breakers with insulating material housings which, for each switching pole, comprise two switching contacts which are pressed resiliently against each other in the switch-on position of the circuit breaker. The switching contacts can be separated by the action of electrodynamic repulsion forces if the current flowing through the switching contacts exceeds a certain threshold value, in order to thereby bring about limiting of the current mentioned.

The circuit breaker disclosed in the documents comprises an overload and/or short-circuit detection element for acting on a disconnection mechanism which automatically disconnects the circuit breaker in the event of a fault. Furthermore, the circuit breaker disclosed in the documents comprises an operating element which responds to an overpressure which is generated in the separation zone of said switching contacts by an electric arc which is struck in the event of electrodynamic repulsion of the switching contacts, in order to operate the disconnection mechanism of the circuit breaker.

DE 2018 211 995 A1 discloses a pressure tripping device for an electrical switch having an operating element and having at least one flow channel for each electrical pole, wherein the at least one pole of the electrical switch comprises at least two switching contacts for closing or interrupting a flow path, wherein the switching contacts of the at least one pole of the electrical switch can be separated via the operating element which can respond to a pressure (p) which is generated in a separation zone of the in each case two switching contacts by an electric arc (LB) which is struck in the event of electrodynamic repulsion of the switching contacts, and wherein the separation zone can be connected to the operating element via the flow channel, wherein the at least one flow channel comprises a non-return valve which permits flow only from the separation zone in the direction of the operating element.

### SUMMARY

The inventors have discovered that when a pressure tripping device of this kind is switched off, heavy soiling can result in the operating element becoming jammed and not being able to be moved to the inoperative position. The inventors have discovered that resetting the operating element via a spring as an alternative solution is not possible since, on account of the installation space, this is too weak for restoring purposes and therefore the switch would lose its function when the operating element is jammed.

At least one embodiment of the invention therefore provides an alternative solution for resetting the electrical switch.

According to at least one embodiment of the invention, a restoring element for an electrical switch is disclosed. Advantageous refinements of the restoring element are specified. According to an embodiment of the invention, an electrical switch is disclosed. Advantageous refinements of the electrical switch are specified.

The restoring element for an electrical switch of at least one embodiment is constructed in two parts from a first part and a second part, wherein the two parts converge in a first direction for tripping the electrical switch and the two parts do not necessarily converge in a second direction for resetting the electrical switch, which second direction is different from the first direction, and wherein the second part of the restoring element has a restoring cam which can interact with a handle of a switching mechanism of the electrical switch, so that, during resetting of the electrical switch, the restoring element is rotated by the handle in the second direction for resetting the electrical switch.

The restoring element for an electrical switch of at least one embodiment, comprises:

a first part; and

a second part, the first part and the second part converging in a first direction for tripping the electrical switch and the first part and the second part not necessarily converging in a second direction for resetting the electrical switch, the second direction being different from the first direction,

the second part of the restoring element including
a restoring cam, configured to interact with a handle of a switching mechanism of the electrical switch, such that, during resetting of the electrical switch, the restoring element is configured to be rotated by the handle in the second direction for resetting the electrical switch.

The electrical switch of at least one embodiment comprises a switching mechanism which has at least one handle and one restoring element according to an embodiment of the invention with a cam for a pressure tripping device, a plurality of poles and a pressure tripping device, wherein the plurality of poles of the electrical switch each comprise at least two switching contacts for closing or interrupting a current path, wherein the switching contacts of the electrical switch are separated via an operating element of the pressure tripping device which responds to a pressure (p) which is generated by an electric arc (LB), which is struck in the event of electrodynamic repulsion of the switching contacts, in a separation zone of the in each case two switching contacts, wherein the operating element, for separating the switching contacts, is moved from an inoperative position to an operating position in which the cam for the pressure tripping device of the restoring element is operated in the first direction and as a result the two parts of the restoring element converge and trip the electrical switch, and wherein, when the electrical switch is reset, the restoring cam is operated by the handle in the second direction of the restoring element and as a result the operating element is restored by the cam for the pressure tripping device to the inoperative position.

An electrical switch of at least one embodiment comprises:

a switching mechanism, including
at least one handle; and
one restoring element including a cam;

the pressure tripping device of an embodiment; and

a plurality of poles, each of the plurality of poles of the electrical switch include at least two switching contacts for closing or interrupting a current path, the at least two switching contacts of each of the plurality of poles of the electrical switch being separated via an operating element of the pressure tripping device, configured to respond to a pressure generated by an electric arc struck in an event of electrodynamic repulsion of the switching contacts, in a separation zone of the at least two switching contacts of each of the plurality of poles of the electrical switch,

wherein the operating element is movable from an inoperative position to an operating position, in which the cam for the pressure tripping device of the restoring element is operated in the first direction and, as a result the two parts of the restoring element, is configured to converge and trip the electrical switch, and

wherein, upon the electrical switch being reset, the restoring cam is configured to be operated by the at least one handle in the second direction of the restoring element and, as a result, the operating element is configured to be restored by the cam for the pressure tripping device to the inoperative position.

### BRIEF DESCRIPTION OF THE DRAWINGS

The above-described properties, features and advantages of this invention, and the manner in which they are achieved, will become clearer and more clearly comprehensible in conjunction with the description below of the exemplary embodiments which will be explained in more detail in conjunction with the figures.

In the figures:

FIG. 1: shows an electrical switch having a pressure tripping device and a restoring element;

FIG. 2: shows an electrical switch having switching contacts, a pressure tripping device and a restoring element;

FIGS. 3A and 3B: show a two-part restoring element;

FIGS. 4A and 4B: show a two-part restoring element; and

FIG. 5: shows a handle and a restoring element having restoring cams.

### DETAILED DESCRIPTION OF THE EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated. The present invention, however, may be embodied in many alternate forms and should not be construed as limited to only the example embodiments set forth herein.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Before discussing example embodiments in more detail, it is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments of the present invention. This invention may, however, be embodied in many alternate forms and should not be construed as limited to only the embodiments set forth herein.

Units and/or devices according to one or more example embodiments may be implemented using hardware, software, and/or a combination thereof. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

The restoring element for an electrical switch of at least one embodiment is constructed in two parts from a first part and a second part, wherein the two parts converge in a first direction for tripping the electrical switch and the two parts do not necessarily converge in a second direction for resetting the electrical switch, which second direction is different from the first direction, and wherein the second part of the restoring element has a restoring cam which can interact with a handle of a switching mechanism of the electrical switch, so that, during resetting of the electrical switch, the restoring element is rotated by the handle in the second direction for resetting the electrical switch.

An advantage is that the restoring element increases the reliability of the electrical switch during resetting. Resetting is mechanically ensured. The function of the restoring element can be executed with a constant quality particularly at high switching power levels and the high degree of soiling which occurs in the process. The increase in the tripping times due to soiling can be virtually avoided by way of the force reset.

In one refinement, the two parts of the restoring element each have function cams. These function cams can interact, for example, with position stops, springs, auxiliary tripping devices, pressure tripping devices or a latching magnet (maglatch).

In a further refinement, the restoring element is designed as a rotatable shaft, wherein the two parts converge in a first rotation direction for tripping the electrical switch and the two parts do not necessarily converge in a second rotation direction for resetting the electrical switch, which second rotation direction is opposite to the first rotation direction.

The electrical switch of at least one embodiment comprises a switching mechanism which has at least one handle and one restoring element according to an embodiment of the invention with a cam for a pressure tripping device, a plurality of poles and a pressure tripping device, wherein the plurality of poles of the electrical switch each comprise at least two switching contacts for closing or interrupting a current path, wherein the switching contacts of the electrical switch are separated via an operating element of the pressure tripping device which responds to a pressure (p) which is generated by an electric arc (LB), which is struck in the event of electrodynamic repulsion of the switching contacts, in a separation zone of the in each case two switching contacts, wherein the operating element, for separating the switching contacts, is moved from an inoperative position to an operating position in which the cam for the pressure tripping device of the restoring element is operated in the first direction and as a result the two parts of the restoring element converge and trip the electrical switch, and wherein, when the electrical switch is reset, the restoring cam is operated by the handle in the second direction of the restoring element and as a result the operating element is restored by the cam for the pressure tripping device to the inoperative position.

In one refinement, further cams which can additionally trip the electrical switch are provided on the first part of the restoring element.

In a further refinement, the operating element of the pressure tripping device is designed as a tappet.

In a further refinement, the tappet is held in an inoperative position by a spring and is operated against the spring force of this spring under pressure (p).

In a further refinement, the electrical switch comprises one, two or three electrical poles and the pressure tripping device comprises three or four flow channels.

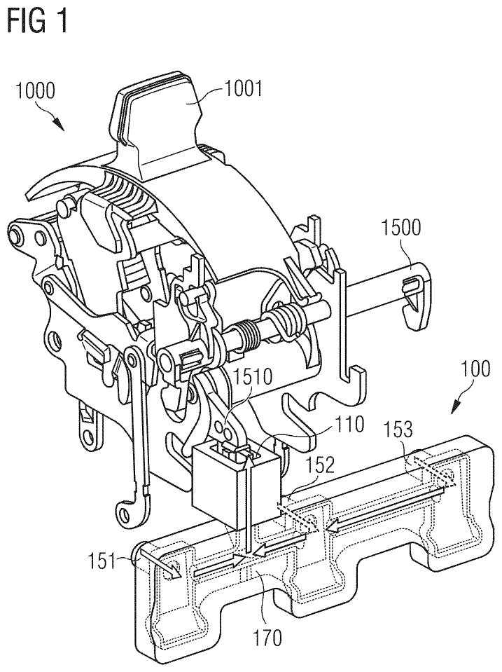

FIG. 1 illustrates a switching apparatus of an electrical switch 1000 having a pressure tripping device 100. The pressure tripping device 100 responds to a pressure (p) which is generated by an electric arc (LB), which is struck in the event of electrodynamic repulsion of the switching contacts, in a separation zone. This increase in pressure generates flow through the flow channel 151 and into the common collection chamber 170. On account of the increase in pressure in the common collection chamber 170, an operating element 110 of the pressure tripping device 100 is deflected upward in accordance with the illustration in FIG. 1 and operates a tripping lever 1510 of the switching mechanism of the electrical switch 1000.

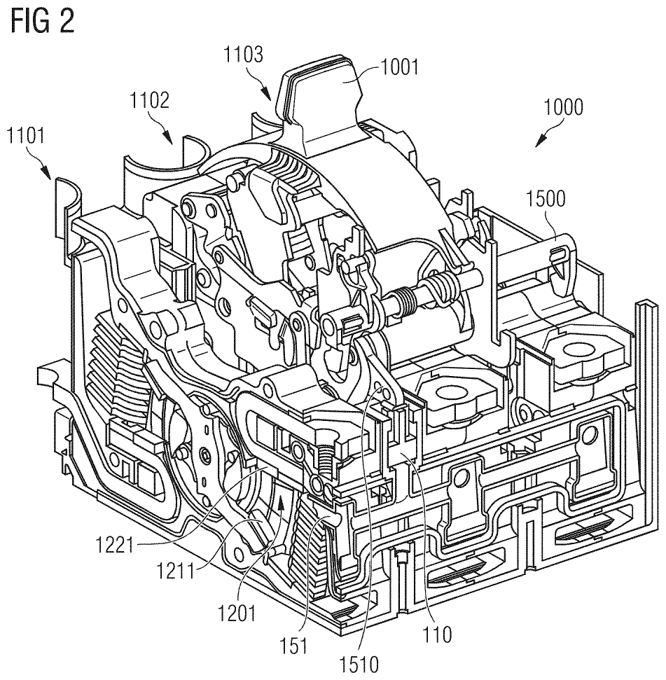

FIG. 2 illustrates a multi-pole electrical switch 1000. It comprises a plurality of poles 1101; 1102; 1103 each having at least two switching contacts 1211, 1221; 1212, 1222; 1213, 1223 for closing or interrupting a current path. Electrical switches 1000 having two switching contacts are called singly interrupting electrical switches, and multiply interrupting switches are referred to when there are more than two switching contacts.

In accordance with FIG. 2, the multi-pole electrical switch 1000 can comprise, for example, three electrical poles 1101; 1102; 1103. The switching contacts 1211, 1221; 1212, 1222; 1213; 1223 of the plurality of poles 1101; 1102; 1103 of the electrical switch 1000 can be separated via an operating element 110 of the pressure tripping device 100, wherein the operating element 110 can respond to a pressure (p) which is generated by an electric arc (LB), which is struck in the event of electrodynamic repulsion of the switching contacts 1211, 1221; 1212, 1222; 1213, 1223, in a separation zone 1201; 1202; 1203 of the in each case two switching contacts 1211, 1221; 1212, 1222; 1213, 1223. The separation zones 1201; 1202; 1203 are connected to the operating element 110 via the flow channels 151; 152; 153. This means that the pressure (p) which is created in the separation zones 1201; 1202; 1203 on account of the struck arc (LB) is conducted in terms of flow within the pressure tripping device 100 to the operating element 110.

The operating element 110 of the pressure tripping device 100 can be designed as a tappet for operating a tripping lever 1510 of the switching mechanism. Furthermore, the operating element 110 can be provided with a spring and held in an inoperative position by this spring. When there is an increase in pressure (p), the operating element 110 can be operated against the spring force of this spring. As a result, the response behavior of the pressure tripping device 100 can be set by selection of the spring for example.

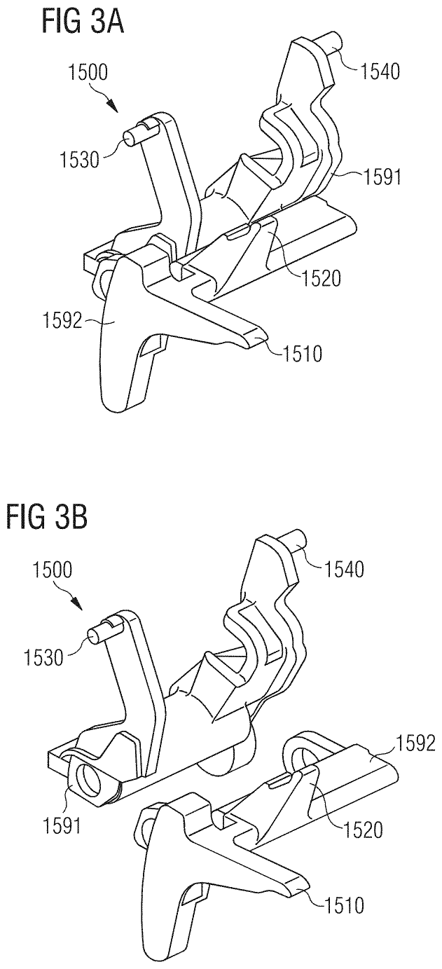

FIGS. 3A and 3B show an embodiment of a restoring element 1500 according to the invention for an electrical switch 1000. This restoring element 1500 is constructed in two parts from a first part 1591 and a second part 1592, wherein the two parts 1591; 1592 converge in a first direction for tripping the electrical switch 1000 and the two parts 1591; 1592 do not necessarily converge in a second direction for resetting the electrical switch 1000, which second direction is different from the first direction.

The second part 1592 of the restoring element 1500 has a restoring cam 1520 which can interact with a handle 1001 of a switching mechanism of the electrical switch 1000, so that, during resetting of the electrical switch 1000, the restoring element 1500 is rotated by the handle 1001 in the second direction for resetting the electrical switch 1000.

The two parts 1591; 1592 of the restoring element 1500 each have further function cams 1510; 1530; 1540. These function cams 1510; 1530; 1540 can interact with position stops, springs, auxiliary tripping devices, pressure tripping devices or a latching magnet (maglatch).

The restoring element can be designed as a rotatable shaft, wherein the two parts 1591; 1592 converge in a first rotation direction for tripping the electrical switch 1000 and the two parts 1591; 1592 do not necessarily converge in a second rotation direction for resetting the electrical switch 1000, which second rotation direction is opposite to the first rotation direction.

FIG. 3A illustrates the restoring element 1500 with a fitted first part 1591 and a fitted second part 1592, and FIG. 3B illustrates the first part 1591 and the second part 1592 separately from one another.

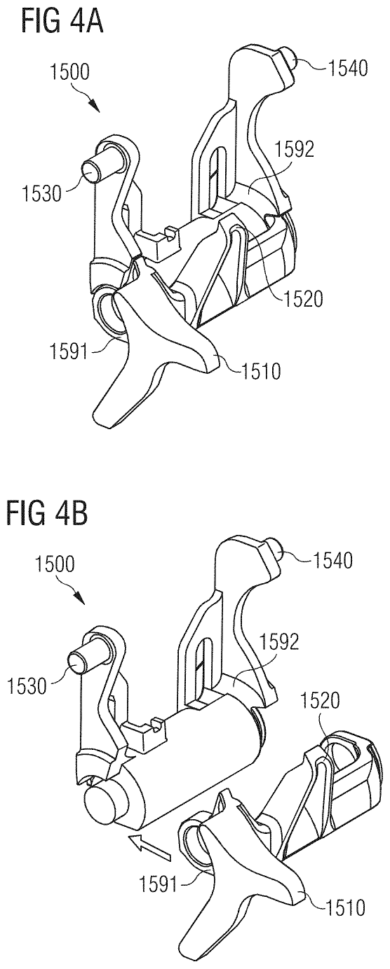

FIGS. 4A and 4B illustrate a further embodiment for the restoring element 1500 for an electrical switch 1000. This restoring element 1500 is also constructed in two parts from a first part 1591 and a second part 1592. The first part 1591 and the second part 1592 are illustrated fitted to one another in the illustration of FIG. 4A, and the two parts 1591; 1592 are illustrated separately in the illustration of FIG. 4B.

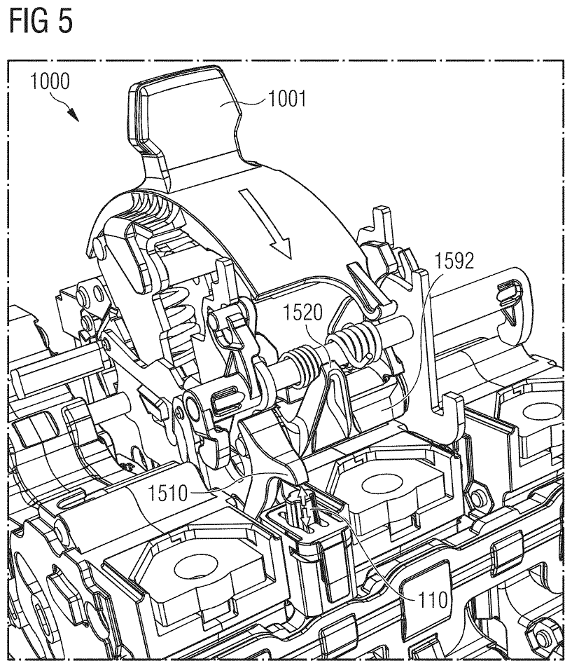

FIG. 5 illustrates the electrical switch 1000 having the handle 1001, and the operating element 110 of the pressure tripping device 100 and the restoring element 1500 with the restoring cam 1520 which can interact with the handle 1001, so that, during resetting of the electrical switch 1000, the restoring element 1500 is rotated by the handle 1001 in the second direction for resetting the electrical switch. In accordance with the illustration of FIG. 5, this means a movement of the handle 1001 in the illustrated arrow direction. As a result of the restoring element 1500 being rotated in the second direction, the operating element 110 is restored to the inoperative position by the cam for the pressure tripping device 1510.

In accordance with the illustration of FIG. 2, the electrical switch 1000 has a handle 1001 and a restoring element 1500 with a cam for a pressure tripping device 1510. The electrical switch 1000 is provided with a plurality of poles 1101; 1102; 1103 and with a pressure tripping device 100, wherein the plurality of poles 1101; 1102; 1103 of the electrical switch 1000 each comprise at least switching contacts 1211, 1221; 1212, 1222; 1213, 1223 for closing or interrupting a current path. Furthermore, the switching contacts 1211, 1221; 1212, 1222; 1213, 1223 of the plurality of poles 1101; 1102; 1103 of the electrical switch 1000 can be separated via an operating element 110 of the pressure tripping device 100 which responds to a pressure (p) which is generated by an electric arc (LB), which is struck in the event of electrodynamic repulsion of the switching contacts 1211, 1221; 1212, 1222; 1213, 1223, in a separation zone 1201; 1202; 1203 of the respective switching contacts 1211, 1221; 1212, 1222; 1213, 1223.

The operating element 110 for separating the switching contacts 1211, 1221; 1212, 1222; 1213, 1223 is moved from an inoperative position to an operating position in which the cam for the pressure tripping device 1510 of the restoring element 1500 is operated in the first direction and as a result the two parts 1591; 1592 of the restoring element 1500 converge and trip the electrical switch 1000.

When the electrical switch 1000 is reset, the restoring cam 1520 is operated by the handle 1001 in the second direction of the restoring element 1500 and as a result the operating element 110 is restored by the cam for the pressure tripping device 1510 to the inoperative position.

Further cams which can additionally trip the electrical switch 1000 can be provided on the first part 1591 of the restoring element 1500.

The operating element 110 of the pressure tripping device can be designed, for example, as a tappet. The tappet can be held in an inoperative position by a spring and can be operated against the spring force of this spring under pressure (p). In this case, when the electrical switch 1000 is reset, the restoring cam 1520 is operated by the handle 1001 in the second direction of the restoring element 1500 by a force which acts additionally to the spring and as a result the operating element 110 is restored by the cam for the pressure tripping device 1510 to the inoperative position.

The electrical switch 1000 according to the invention can comprise one, two or three electrical poles 1101; 1102; 1103 and the pressure tripping device 100 can have three or four flow channels 151; 152; 153.

The restoring element 1500 according to the invention or the electrical switch 1000 having such a restoring element 1500 allows a force reset of the operating element 110, for example a tappet of a pressure tripping device 100. As a result, the reliability of the electrical switch 1000 is increased. This resetting is mechanically ensured. The function can be executed with a constant quality particularly at high switching power levels and the high degree of soiling which occurs in the process. An increase in the tripping times, for example due to soiling, can be virtually avoided by way of the force reset.

The patent claims of the application are formulation proposals without prejudice for obtaining more extensive patent protection. The applicant reserves the right to claim even further combinations of features previously disclosed only in the description and/or drawings.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

None of the elements recited in the claims are intended to be a means-plus-function element within the meaning of 35 U.S.C. § 112(f) unless an element is expressly recited using the phrase “means for” or, in the case of a method claim, using the phrases “operation for” or “step for.”

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A restoring element for an electrical switch, comprising:
a first part; and
a second part, the first part and the second part converging in a first direction for tripping the electrical switch and the first part and the second part not necessarily converging in a second direction for resetting the electrical switch, the second direction being different from the first direction,
the second part of the restoring element including
a restoring cam, configured to interact with a handle of a switching mechanism of the electrical switch, such that, during resetting of the electrical switch, the restoring element is configured to be rotated by the handle in the second direction for resetting the electrical switch.

2. The restoring element of claim 1, wherein the first part and the second part each respectively include a function cam.

3. The restoring element of claim 2, wherein the function cams of the first part and the second part are configured to interact with respective position stops, springs, auxiliary tripping devices, pressure tripping devices or a latching magnet.

4. The restoring element of claim 1, wherein the restoring element is designed as a rotatable shaft, wherein the first part and the second part are configured to converge in a first rotation direction for tripping the electrical switch and wherein the first part and the second part are configured to not necessarily converge in a second rotation direction for resetting the electrical switch, the second rotation direction being opposite to the first rotation direction.

5. An electrical switch comprising:
a switching mechanism, including
at least one handle; and
one restoring element including a cam;
the pressure tripping device of claim 1; and
a plurality of poles, each of the plurality of poles of the electrical switch include at least two switching contacts for closing or interrupting a current path, the at least two switching contacts of each of the plurality of poles of the electrical switch being separated via an operating element of the pressure tripping device, configured to respond to a pressure generated by an electric arc struck in an event of electrodynamic repulsion of the switching contacts, in a separation zone of the at least two switching contacts of each of the plurality of poles of the electrical switch,
wherein the operating element is movable from an inoperative position to an operating position, in which the cam for the pressure tripping device of the restoring element is operated in the first direction and, as a result the two parts of the restoring element, is configured to converge and trip the electrical switch, and
wherein, upon the electrical switch being reset, the restoring cam is configured to be operated by the at least one handle in the second direction of the restoring element and, as a result, the operating element is configured to be restored by the cam for the pressure tripping device to the inoperative position.

6. The electrical switch of claim 5, wherein further cams, configured to additionally trip the electrical switch, are provided on the first part of the restoring element.

7. The electrical switch of claim 5, wherein the operating element of the pressure tripping device is designed as a tappet.

8. The electrical switch of claim 7, wherein the tappet is held in an inoperative position by a spring and configured to be operated against the spring force of the spring, under pressure.

9. The electrical switch of claim 5, wherein the electrical switch comprises one, two or three electrical poles and wherein the pressure tripping device comprises three or four flow channels.

10. The restoring element of claim 2, wherein the restoring element is designed as a rotatable shaft, wherein the first part and the second part are configured to converge in a first rotation direction for tripping the electrical switch and wherein the first part and the second part are configured to not necessarily converge in a second rotation direction for resetting the electrical switch, the second rotation direction being opposite to the first rotation direction.

11. The restoring element of claim 3, wherein the restoring element is designed as a rotatable shaft, wherein the first part and the second part are configured to converge in a first rotation direction for tripping the electrical switch and wherein the first part and the second part are configured to not necessarily converge in a second rotation direction for resetting the electrical switch, the second rotation direction being opposite to the first rotation direction.

12. The electrical switch of claim 6, wherein the operating element of the pressure tripping device is designed as a tappet.

13. The electrical switch of claim 12, wherein the tappet is held in an inoperative position by a spring and configured to be operated against the spring force of the spring, under pressure.
